(19) United States
(12) Patent Application Publication
(10) Pub. No.: US 2012/0077162 A1
(43) Pub. Date: Mar. 29, 2012

(54) CONDITIONING AN ORGANISM

(75) Inventors: Jeroen Veen, Eindhoven (NL); Stijn De Waele, Eindhoven (NL)

(73) Assignee: KONINKLIJKE PHILIPS ELECTRONICS N.V., EINDHOVEN (NL)

(21) Appl. No.: 13/375,808

(22) PCT Filed: Jun. 8, 2010
(86) PCT No.: PCT/IB10/52543

§ 371 Date: Dec. 2, 2011

(30) Foreign Application Priority Data
Jun. 12, 2009 (EP) 09162604.4

(51) Int. Cl. G09B 19/00

(52) U.S. Cl. 434/236

(57) ABSTRACT

A system for conditioning an organism by associating a conditioned response with a conditioned stimulus, the system comprising the following. Identifying means for identifying a signal pattern associated with a conditioned response (201). Measuring means for measuring a signal of the organism for obtaining a measured signal (202). A comparer for comparing the measured signal with the signal pattern (203). A stimulus renderer for rendering a conditioned stimulus (204) when the measured signal matches the signal pattern, for conditioning the organism such that it associates the conditioned stimulus with the conditioned response, and for further rendering the conditioned stimulus for evoking the conditioned response, at a time which depends on the measured signal.

### FIELD OF THE INVENTION

The invention relates to a system, method and computer program for conditioning an organism.

### BACKGROUND OF THE INVENTION

Classical conditioning is a form of associative learning in organisms, which was first demonstrated by Ivan Pavlov. Classical conditioning involves repetitive pairing of an event (the unconditioned stimulus US) that evokes a particular behavioral response in an organism (the unconditioned response UR) with another previously neutral event (the conditioned stimulus), which does not normally evoke that particular behavioral response. If the conditioned stimulus (CS) and the unconditioned stimulus (US) are repeatedly offered to the organism as a pair, eventually the organism will associate the two stimuli with each other. As a result, the conditioned stimulus, when offered to the organism, also elicits the particular behavioral response. The particular behavioral response has become a conditioned response (CR) associated with the conditioned stimulus.

It is also possible to let the conditioned stimulus be offered by an observer. Whenever the observer observes a particular behavior in the organism, he offers the conditioned stimulus to the organism. This similarly causes the organism to be conditioned because it associates the conditioned stimulus with the particular behavior. The stimulus offered is then a conditioned stimulus and the particular behavior becomes a conditioned response.

### SUMMARY OF THE INVENTION

It would be advantageous to have an improved system for conditioning an organism. To better address this concern, in a first aspect of the invention a system is presented that can associate a conditioned response with a conditioned stimulus. The system comprises

identifying means for identifying a signal pattern associated with a conditioned response;

measuring means for measuring a signal of the organism for obtaining a measured signal;

a comparer for comparing the measured signal with the signal pattern;

a stimulus renderer for rendering a conditioned stimulus when the measured signal matches the signal pattern, for conditioning the organism such that it associates the conditioned stimulus with the conditioned response.

By identifying a signal pattern associated with the conditioned response (or, more specifically, the to-be conditioned response), a measured signal can be used and compared with the signal pattern to detect whether the organism is giving the conditioned response (or to-be conditioned response). This way, it is not necessary to detect the conditioned response directly. It is also not necessary to actively elicit the (to-be) conditioned response by offering an unconditioned stimulus. The system simply may wait and continue measuring the signal until a match is established between the measured signal and the signal pattern. When a match is established, the conditioned stimulus may be rendered to create or reinforce the association between the (to-be) conditioned stimulus and the (to-be) conditioned response. Such a signal can be measured automatically using a sensor, and the measured signal can be compared with the signal pattern using signal analysis techniques known in the art per se. Consequently, the system may be automated. Moreover, the measured signal and signal pattern can be used to detect an emotional state; because of this, the system is capable of conditioning an emotional state as the conditioned response.

The stimulus renderer may be arranged for further rendering the conditioned stimulus for evoking the conditioned response. This way, the same integrated system can be used to condition the organism and to elicit the conditioned response. The further rendering may be performed in response to a user input, for example provided by the organism itself or a separate control user.

The stimulus renderer may be arranged for performing said further rendering at a time which depends on the measured signal. This allows to automate the application of the conditioned stimulus for evoking the conditioned response.

The stimulus renderer may be arranged for performing said further rendering at a time when the measured signal does not match the signal pattern. If the measured signal does not match the signal pattern, it may be assumed that the organism is not in the desired state. Consequently, this is a good time to offer the conditioned stimulus in order to bring the organism into the desired state (corresponding to the conditioned response).

The system may further comprise further identifying means for identifying a further signal pattern associated with an undesired response. The comparer may be arranged for comparing the measured signal with the further signal pattern. Moreover, the stimulus renderer may be arranged for performing said further rendering when the measured signal matches the further signal pattern. This assists the organism to automatically stop a behavior or leave a particular undesired emotional state, for example.

The conditioned response may comprise at least one of: a mental state, an emotional state, a transition of a mental state, or a transition of an emotional state. These kinds of states or transitions can be assessed based on measured physiological signals of the organism. Consequently, such conditioned responses can be trained by the system without much user interaction or fully automatically.

The signal may comprise a physiological signal of the organism. Such signals can be used to detect an emotional state, for example. Moreover, these can be measured by sensors known in the art per se.

The physiological signal may comprise at least one of: electroencephalogram (EEG), magnetoencophalogram (MEG), galvanic skin response (GSR), electromyogram (EMG), electrocardiogram (ECG). Such physiological, electrical signals offer substantial information about the emotional state of the organism.

The conditioned stimulus may comprise at least one of: an odor, a haptic stimulus, an acoustic stimulus, or a visual stimulus. Such stimuli can be associated with a conditioned response.

The system may comprise a control input for receiving an indication that the organism is producing the conditioned response. This allows the system to calibrate itself without explicit a prior knowledge of the signal pattern associated with a particular behavior or emotional state.

The identifying means may be arranged for identifying the signal pattern in dependence on the measured signal at about the time of receiving the indication. This is an efficient way to generate the signal pattern.

The stimulus renderer may be arranged for rendering the conditioned stimulus when the measured signal matches the signal pattern, repeatedly over a time interval. The more training, the better the conditioned stimulus will be associated with the conditioned response.

A system for evoking a conditioned response in an organism may comprise a stimulus renderer. The stimulus renderer may be arranged for rendering a conditioned stimulus for obtaining the conditioned response in an organism which has been conditioned by the system set forth. Such a system for evoking a conditioned response profits from the conditioning resulting of the conditioning system set forth.

A method of conditioning an organism by associating a conditioned response with a conditioned stimulus, may comprise

identifying a signal pattern associated with a conditioned response;

measuring a signal of the organism for obtaining a measured signal;

comparing the measured signal with the signal pattern; and

rendering the conditioned stimulus when the measured signal matches the signal pattern, for conditioning the organism such that it associates the conditioned stimulus with the conditioned response.

A computer program product may comprise instructions for causing a processor system to perform the steps of the method set forth.

It will be appreciated by those skilled in the art that two or more of the above-mentioned embodiments, implementations, and/or aspects of the invention may be combined in any way deemed useful.

### BRIEF DESCRIPTION OF THE DRAWINGS

These and other aspects of the invention will be further elucidated and described with reference to the drawing, in which

FIG. 1 is a block diagram of a system for conditioning an organism; and

FIG. 2 is a block diagram of a method of conditioning an organism.

### DETAILED DESCRIPTION OF EMBODIMENTS

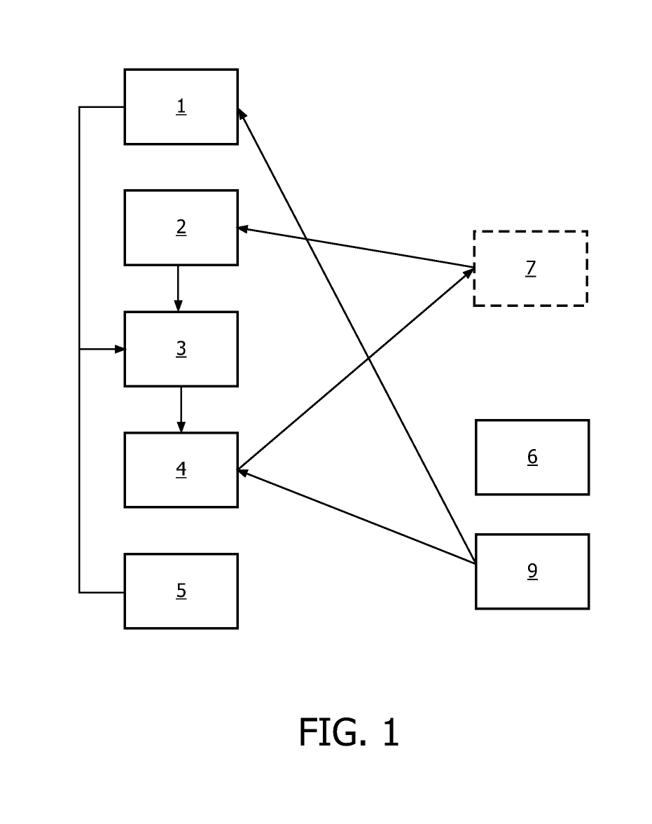

FIG. 1 shows a block diagram of a system for conditioning an organism 7. The system can be used to condition the organism 7 such that it gives a conditioned response to a conditioned stimulus. Such a conditioned response may comprise a particular state of the organism, such as an emotional state. After conditioning, the conditioned response may be evoked in the organism 7 by offering the conditioned stimulus. To this end, during a training phase, the conditioned stimulus is offered at times when the organism is in the particular state of the conditioned response. The system may comprise one or more storage media, such as a RAM, ROM, or flash memory, or on a magnetic or optical disc. The system may further comprise one or more processors, for executing a program stored in the storage media. The system may also be implemented by a dedicated electronic circuit.

The system may comprise identifying means 1 for identifying a signal pattern associated with a conditioned response. For example, the signal pattern may be stored on the storage medium.

The system may comprise measuring means 2 for measuring a signal of the organism 7 for obtaining a measured signal. The measuring means 2 may comprise a sensor. The sensor may comprise an ECG sensor, which may be attached to the body of the organism 7, for example. Other examples will be described hereinafter. The measured signal may be temporarily (or permanently) stored on the storage medium.

The system may further comprise a comparer 3 for comparing the measured signal with the signal pattern. Such comparison can comprise signal processing operations. The comparer 3 can be implemented as a digital signal processing module, for example in software. For example, cross correlation may be used to compare the measured signal with the signal pattern. These and other usable comparison techniques are known in the art per se. The result of the comparer 3 may comprise a binary decision whether the measured signal matches the signal pattern, yes or no. The result may also comprise a probability or likelihood that the measured signal matches the signal pattern.

The system may further comprise a stimulus renderer 4 for rendering a conditioned stimulus when the measured signal matches the signal pattern. This way, the organism may be conditioned such that it associates the conditioned stimulus with the conditioned response. The conditioned stimulus may take one of many different forms. Preferably, one particular stimulus is used to condition one particular response. The stimulus renderer 4 may comprise a controller for controlling a device which generates the actual stimulus. The stimulus renderer may also comprise the device which generates the stimulus. Such a device may comprise a haptic shirt. Such a haptic shirt can apply a pressure to a body part. The device may also comprise a speaker for generating an acoustic signal, for example. Other examples are given elsewhere in this description.

The stimulus renderer 4 may be arranged for further rendering the conditioned stimulus for evoking the conditioned response. This is another operating mode, in which the stimulus may be rendered even if the measured signal does not match the signal pattern. After the organism has been sufficiently conditioned, this operating mode may be used to evoke the conditioned response in the organism by offering the organism the conditioned stimulus. For example, the system may comprise a user input 9 for receiving a command to render the conditioned stimulus. This command may be given by the conditioned organism or by a third party such as a supervisor. The stimulus renderer 4 may also have an operating mode in which the conditioned stimulus is rendered at regular intervals, for example, to cause the organism to enter into and remain in the (e.g. emotional) state corresponding to the conditioned response. If the operating mode does not need the measured signal, the measuring means 2 and/or the comparer 3 may be temporarily switched off, for example.

The stimulus renderer 4 may also be arranged for performing said further rendering at a time which depends on the measured signal. This allows the system to supervise the organism and offering the conditioned stimulus at appropriate times, as indicated by the measured signal. The appropriate time may be established using a pattern recognition technique, for example. The stimulus renderer 4 may be arranged for performing said further rendering at a time when the measured signal does not match the signal pattern. For example, the measuring means 2 may continue to measure a signal of the organism 7 and the comparer may continue to compare the measured signal with the signal pattern. If the measured signal does not match the signal pattern, apparently the organism is not in the state corresponding to the conditioned response. To cause the organism to get into that state, the conditioned stimulus may be offered to the organism.

Further identifying means 5 may be provided for identifying a further signal pattern associated with an undesired response. Such further identifying means 5 may be implemented in a way similar to the identifying means 1, for example. The comparer may be arranged for comparing the measured signal with the further signal pattern. The stimulus renderer may be arranged for performing said further rendering when the measured signal matches the further signal pattern. This way, a different operating mode is established. The further signal pattern may correspond to some undesired response. “Undesired response” in this context means that it is the intention to at least partially change the state of the organism by offering the conditioned stimulus to evoke the conditioned response.

The conditioned response may comprise, for example, one or more of: a mental state, an emotional state, a transition of a mental state, or a transition of an emotional state. Such a transition may comprise a transition from a first mental or emotional state to a second, different mental or emotional state. A transition can have its own associated signal pattern. The identifying means 1 may comprise a database of signal patterns, each signal pattern being associated with a mental and/or emotional state or a transition between states. The system may, for example, be programmable via the user input 9 to select a state (and corresponding signal pattern) to be used by the comparer 3 in the comparison.

The signal measurer 2 may be arranged to measure any kind of signal of the organism. For example, the signal may comprise a physiological signal of the organism. Such a physiological signal may comprise an electrical signal. A physiological signal may comprise, for example, an electroencephalogram (EEG), a magnetoencophalogram (MEG), a galvanic skin response (GSR), an electromyogram (EMG), or an electrocardiogram (ECG). A physiological signal may relate to the respiration.

The stimulus renderer 4 may be arranged for generating, for example, an odor, a haptic stimulus, an acoustic stimulus, or a visual stimulus. Correspondingly, the stimulus renderer 4 may comprise an odor generator, an actuator, a speaker, a light, and/or a display.

The system may comprise a control input, for example comprising a user input 9, for receiving an indication that the organism is producing the conditioned response, i.e., that the organism is in the corresponding state. Such indication may be given by the organism 7 itself or by a third party. Accordingly, the user interface may be provided on a device worn by the organism 7, or it may be provided by a remote control, for example. The identifying means 1 may be arranged for identifying the signal pattern in dependence on the signal of the organism at about the time of receiving such an indication. This way, the system may be calibrated for a new state for which no signal pattern is available yet. The identifying means 1 may be arranged for adapting an existing signal pattern in dependence on the signal of the organism at about the time of receiving the indication. “About the indicated time” may be understood to comprise a time interval shortly before, shortly after, or around the time indicated by the control input. It is also possible to allow the user to indicate the interval to be used. It is also possible to enable the user to indicate the time retroactively. As long as the measured signal is stored, it can be used to derive a signal pattern from it.

The stimulus renderer 4 may be arranged for rendering the conditioned stimulus when the measured signal matches the signal pattern, repeatedly during a time interval, for example for at least more than two days. The longer the time of the conditioning process, the stronger the association may become in the organism.

It is noted that two different operating modes have been described above, in particular a conditioning mode and a use mode or evocation mode. The conditioning mode meaning the mode in which the conditioned stimulus is offered when the conditioned response is detected through the measured signal in order to strengthen the association between the conditioned stimulus and the conditioned response in the organism. The use mode or evocation mode meaning the mode in which the conditioned stimulus is offered in order to evoke the conditioned response. These two modes can be active consecutively. For example, it is possible to apply the conditioning mode for any given period (for example, one month), after which the evocation mode may be applied for an indefinite period. Whenever the association weakens, the conditioning mode may be re-entered for a while. It is also possible to apply both modes simultaneously. For example, the conditioned stimulus is offered regularly in conditioning mode to keep the association strong. However, the conditioned stimulus is also given in evocation mode, for example when an undesired state is detected or when a user input is received. The two operating modes may be implemented in a single system, for example an apparatus or a device or a couple of devices. For example, the system comprises a shirt with measurement capabilities and haptic capabilities and electronics necessary to control these capabilities. Such a system can be arranged to be capable to perform both operating modes, either consecutively or simultaneously.

It is also possible to provide a system arranged to operate only in the conditioning mode. Such a system may comprise, for example, identifying means 1, measuring means 2, a comparer 3, a stimulus renderer 4, and optionally a user input 9.

It is also possible to provide a system arranged to operate only in the evocation mode. Such a system for evoking a conditioned response in an organism 7, may comprise a stimulus renderer 4 arranged for rendering a conditioned stimulus for obtaining the conditioned response in an organism which has been conditioned by the system arranged to operate in the conditioning mode. A pair of systems may be produced, one operating in the conditioning mode and another operating in the evocation mode.

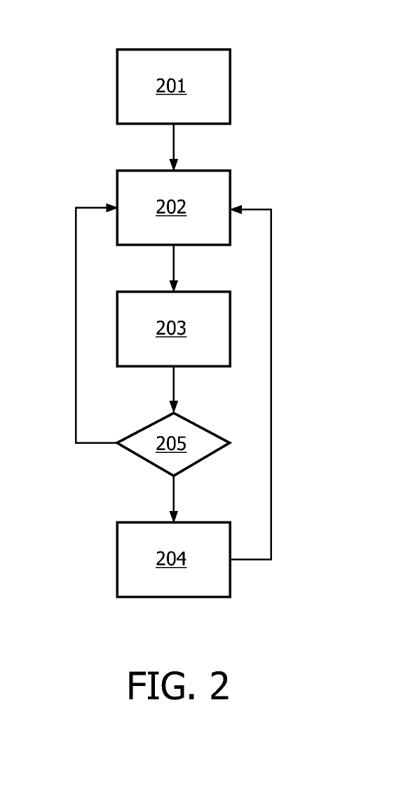

FIG. 2 illustrates a process of conditioning an organism by associating a conditioned response with a conditioned stimulus. In step 201, a signal pattern is identified associated with a to-be conditioned response. In step 202, a signal of the organism is measured for obtaining a measured signal. In step 203, the measured signal is compared with the signal pattern. In step 205, it is established if a conditioned stimulus is to be rendered. One condition is that the output of step 203 is that the measured signal matches the signal pattern. Moreover, a time constraint may be imposed here, for example, the conditioned stimulus may only be rendered if the last conditioned stimulus was offered more than a threshold time duration ago. If it is established in step 205 that a conditioned stimulus is to be rendered, in step 204, the conditioned stimulus is rendered for conditioning the organism such that it associates the conditioned stimulus with the conditioned response. After step 205 (if no conditioned stimulus is offered) or after step 204 (after a conditioned stimulus has been offered), the process continues from step 202. It is noted that some of the steps may be performed in parallel, for example the measuring may be performed substantially continuously; the comparison being performed at given intervals, for example. The method may be implemented at least partly in software. This software may be arranged to control and/or receive input from the sensors of the measuring means 2. The software may further be arranged to control the signal renderer 4.

Common examples of emotional conditioning from daily life include the happy feeling that one experienced in the presence of a certain person can be triggered by the smell of the particular perfume that person wore, the sense of arousal that is activated when hearing a specific song that was popular years ago and one used to listen to frequently, and fear conditioning, in which e.g. a certain taste is associated wrongfully with stomach ache based on the past experience one has had of eating some distinctive food prior to falling ill.

These cases of coincidental conditioning show a conditioned emotional response (CER) to a conditioned stimulus CR. Besides the coincidental conditioning as described in the examples above, purposeful use of conditioning occurs for example in advertising and in hypnosis.

However, conditioning may also be used for other purposes, for example to aid a user in concentrating or for reducing stress.

Classical conditioning (in particular classical emotion conditioning) may be accelerated by the techniques disclosed in the present description. Classical emotion conditioning may also be better controlled and/or more targeted. Also, it is not necessary to know which unconditioned stimuli, if any, generate the desired response. This may be particularly advantageous if an unconditioned stimulus inciting the to-be conditioned response is not known or is unpractical to offer to the user. For example, when the desired response is an emotion, the corresponding unconditioned stimulus is often not (well) known. Another advantage of the techniques described herein is that conditioning may be done as part of daily life. It is not necessary to set up an artificial environment or training program to strengthen the conditioning link.

A method of performing classical conditioning may comprise:

1. Measuring physiological signals
2. Estimating a mental state or an emotion from the physiological signals
3. Whenever a desired emotional state is detected, a stimulus is offered to the user.

With sufficient occurrences of 3), this stimulus (the conditioned stimulus) becomes paired with the desired mental state, such that said state can (at least partly) be evoked in the future by offering the conditioned stimulus.

Examples of emotional states in this context are for example relaxation, concentration, happiness, sleepiness and alertness. Most of these emotional states are at least experienced occasionally by most people. This fact may be exploited by offering the stimulus whenever the desired emotional state is detected (step 3 of method above). Such a method may be implemented in a device or system which measures the physiological signals and offers the stimulus when appropriate.

An emotion is a mental state which may be the result of a wide variety of feelings, thoughts, and behaviors. Emotions are generally accompanied by physical reactions such as piloerection, and slowing, acceleration, or increased variability of heart-rate, as well as variations in facial expression, in electrodermal response, and in intestinal peristalsis. External assessment of an organism's emotional state can be done by means of physiological measurements, e.g. electroencephalogram (EEG), magnetoencophalogram (MEG), galvanic skin response (GSR), electromyogram (EMG), electrocardiogram (ECG).

An organism's emotional state may be assessed based on physiological measurements, and when a predefined state is present, (repetitive) pairing with a conditioned stimulus may be performed, such that said state is (at least partly) recallable in future by offering the conditioned stimulus again. Different conditional emotional responses can be associated with different conditioned stimuli, such that a variety of emotional states can be evoked by offering the appropriate associated conditioned stimulus. The conditioned stimulus preferably comprises a machine controllable variable and may work on any part of the organism's sensory system, such as vision, hearing, smell, taste, and/or touch. Examples include acoustic stimulation (e.g. sound, music), tactile stimulation (e.g. vibration), electrical stimulation, visual stimulation (e.g. light flashing), olfactory stimulation (e.g. odors).

The system and method can be applied in at least two modes. With simultaneous conditioning, the conditioned stimulus is offered while the conditioned response is detected. Once successfully paired, the conditioned response can be evoked by offering the conditioned stimulus. With “backward” conditioning, the conditioned stimulus is offered after an undesired state has been left or during a transition from an undesired state to a less undesired state. This can help a person to make the transition, for example from nervous to concentrated or relaxed.

Next to conditioning on a fixed emotion, the system may also learn about the user's desired emotional state, for example in the following fashion. When the user is experiencing the emotion that he wants to recall, he indicates this to the system. The system then creates a ‘setpoint’ based on the current physiological signals, thus learning about the desired state by example. Afterwards, automatic pairing of a stimulus to this emotion can then be done by providing the trigger when the physiological signals are similar to the setpoint. The setpoint may be based on physiological signals of a plurality of times the user has experienced the emotion.

Two types of applications can be considered. First, to cause a desired emotion. The system may apply the conditioned stimulus when the user indicates that he want to get into the desired emotional state which is the conditioned emotional response. Alternatively, the system detects whether the user has the desired emotional state. If not, the system offers the conditioned stimulus. Second, to dispose of an undesired emotion. The system monitors whether the conditioned subject has the undesired emotion by analyzing the measured physiological signals. If the undesired emotion is detected, the system offers the conditioned stimulus to cause a transition of the emotional state to a more desired state.

A concentration aid may comprise an ECG with build-in respiration belt to measure heart and respiration rates. A tactile shirt, capable of exerting pressure on specific parts of the body, may be used to render the conditioned stimulus. Physiological signals including heart rate and/or respiration rate may be measured. The presence of coherence between heart rate and respiration may be detected to decide whether a person is concentrated. When the level of coherence exceeds a certain level, concentration is detected, and the tactile shirt executes a specific pattern of touch to the user (the conditioned stimulus).

Once the conditioned stimulus is sufficiently trained, it can be applied at request of the user, or automatically whenever the user is lacking concentration. Ongoing pairing with the desired state (concentration in this case) would help to keep a strong association between the conditioned stimulus and the conditioned response in the subject.

A mental stress reduction aid may be useful, for example, for workers with psychologically stressful jobs with a moderate or low physical load, such as clerical, call-centre, or cashier work. The mental stress reduction aid may comprise a heart monitoring ECG shirt with built-in respiratory sensor to measure heart and respiration depth. The shirt may further comprise (non-contact) electrodes to measure trapezius muscle EMG. Tactile actuators in the shirt may be capable of exerting pressure on specific parts of the torso. These tactile actuators may be used to render the conditioned stimulus. Physiological signals may be measured, such as heart rate, respiration depth and trapezius muscle tension. Deep breathing, low heart rate and low trapezius muscle tension may indicate that a person is relaxed. The combined physiological measurements may provide a stress level parameter. When the measured stress level drops below a certain threshold, after the undesired stressful state has ended, the tactile shirt may execute a specific pattern of touch to the user to train this as a conditioned stimulus for the conditioned response, the latter comprising a transition from relative stress to relative relaxation.

Once the conditioned stimulus is sufficiently trained, it can be applied at request of the user. Alternatively, it can also be applied automatically: when the system detects that the user's stress level is increased, the trigger may be applied. As long as the stress level is high, the trigger may be applied repeatedly at a certain rate. When application of the trigger is not successful, application of the trigger may be stopped after a certain time, to prevent annoyance and to prevent weakening the pairing. When application of the trigger is not successful for a longer time, it can be decided to restart pairing using a new trigger.

Ongoing pairing of the conditioned stimulus with the conditioned response comprising the desired state (low mental stress level in this case) may help to keep a strong link.

Emotions can have an impact on our physical well-being and lifestyle. The techniques described herein may help to better control such emotions. Applications include concentration aids, relaxation devices, augmented experiences, weight control, and substance abuse.

Another application area is found in the area of mental healthcare. Behavior therapy is a form of psychotherapy to treat depression, anxiety disorders, phobias, chronic pain, obsessive-compulsion disorders and other forms of psychopathology based on the principles of classical conditioning. Behavioral therapy, for example, may be assisted by an emotional conditioning device based on the techniques described herein. Such a device may estimate the patient's emotional state and when a positive emotion is present the device may apply a conditioned stimulus, such that the conditioned emotional response and the conditioned stimulus become paired. Later, when the patient experiences fear and anxiety set off by e.g. a phobia, the device may apply the conditioned stimulus to override or diminish the anxiety by causing the conditioned emotional response.

It will be appreciated that the invention also extends to computer programs, particularly computer programs on or in a carrier or medium, adapted for putting the invention into practice. The program may be in the form of source code, object code, a code intermediate source and object code such as partially compiled form, or in any other form suitable for use in the implementation of the method according to the invention. It will also be appreciated that such a program may have many different architectural designs. For example, a program code implementing the functionality of the method or system according to the invention may be subdivided into one or more subroutines. Many different ways to distribute the functionality among these subroutines will be apparent to the skilled person. The subroutines may be stored together in one executable file to form a self-contained program. Such an executable file may comprise computer executable instructions, for example processor instructions and/or interpreter instructions (e.g. Java interpreter instructions). Alternatively, one or more or all of the subroutines may be stored in at least one external library file and linked with a main program either statically or dynamically, e.g. at run-time. The main program contains at least one call to at least one of the subroutines. Also, the subroutines may comprise function calls to each other. An embodiment relating to a computer program product comprises computer executable instructions corresponding to each of the processing steps of at least one of the methods set forth. These instructions may be subdivided into subroutines and/or be stored in one or more files that may be linked statically or dynamically. Another embodiment relating to a computer program product comprises computer executable instructions corresponding to each of the means of at least one of the systems and/or products set forth. These instructions may be subdivided into subroutines and/or be stored in one or more files that may be linked statically or dynamically.

The carrier of a computer program may be any medium, including any entity or device capable of carrying the program. For example, the carrier may include a storage medium, such as a ROM, for example a CD ROM or a semiconductor ROM, or a magnetic recording medium, for example a floppy disc or hard disk. Further the carrier may be a transmissible carrier such as an electrical or optical signal, which may be conveyed via electrical or optical cable or by radio or other means. When the program is embodied in such a signal, the carrier may be constituted by such cable or other device or means. Alternatively, the carrier may be an integrated circuit in which the program is embedded, the integrated circuit being adapted for performing, or for use in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A system for conditioning an organism by associating a conditioned response with a conditioned stimulus, comprising
identifying means (1) for identifying a signal pattern associated with a conditioned response;
measuring means (2) for measuring a signal of the organism for obtaining a measured signal;
a comparer (3) for comparing the measured signal with the signal pattern;
a stimulus renderer (4) for rendering a conditioned stimulus when the measured signal matches the signal pattern, for conditioning the organism such that it associates the conditioned stimulus with the conditioned response.

2. The system according to claim 1, the stimulus renderer (4) being arranged for further rendering the conditioned stimulus for evoking the conditioned response.

3. The system according to claim 2, the stimulus renderer (4) being arranged for performing said further rendering at a time which depends on the measured signal.

4. The system according to claim 3, the stimulus renderer (4) being arranged for performing said further rendering at a time when the measured signal does not match the signal pattern.

5. The system according to claim 3, further comprising
further identifying means (5) for identifying a further signal pattern associated with an undesired response;
the comparer (3) being arranged for comparing the measured signal with the further signal pattern;
the stimulus renderer (4) being arranged for performing said further rendering when the measured signal matches the further signal pattern.

6. The system according to claim 1, the conditioned response comprising at least one of: a mental state, an emotional state, a transition of a mental state, or a transition of an emotional state.

7. The system according to claim 1, the signal comprising a physiological signal of the organism.

8. The system according to claim 7, the physiological signal comprising at least one of: electroencephalogram (EEG), magnetoencophalogram (MEG), galvanic skin response (GSR), electromyogram (EMG), electrocardiogram (ECG).

9. The system according to claim 1, the conditioned stimulus comprising at least one of: an odor, a haptic stimulus, an acoustic stimulus, or a visual stimulus.

10. The system according to claim 1, further comprising a control input for receiving an indication of a time at which the organism is producing the conditioned response.

11. The system according to claim 10, the identifying means (1) being arranged for identifying the signal pattern in dependence on the signal of the organism at about the indicated time.

12. The system according to claim 1, wherein the stimulus renderer (4) is arranged for rendering the conditioned stimulus when the measured signal matches the signal pattern, repeatedly over a time interval.

13. A system for evoking a conditioned response in an organism, comprising a stimulus renderer arranged for rendering a conditioned stimulus for obtaining the conditioned response in an organism which has been conditioned by the system according to claim 1.

14. A method of conditioning an organism by associating a conditioned response with a conditioned stimulus, comprising
identifying (201) a signal pattern associated with a conditioned response;
measuring (202) a signal of the organism for obtaining a measured signal;
comparing (203) the measured signal with the signal pattern; and
rendering (204) the conditioned stimulus when the measured signal matches the signal pattern, for conditioning the organism such that it associates the conditioned stimulus with the conditioned response.

15. A computer program product comprising instructions for causing a processor system to perform the steps of the method according to claim 14.
